(19) United States
(12) Patent Application Publication
(10) Pub. No.: US 2002/0092804 A1
(43) Pub. Date: Jul. 18, 2002

(54) Insert for housing

(76) Inventor: Walter L. Smith JR., (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/990,589

(22) Filed: Nov. 19, 2001

Related U.S. Application Data
(60) Provisional application No. 60/252,797, filed on Nov. 21, 2000.

(51) Int. Cl. B01D 29/33

(52) U.S. Cl. 210/232; 210/323.2; 210/239

(57) ABSTRACT

A polymer filtration unit with a filter housing that is adapted to receive a removable housing insert. The housing insert adapts the housing to receiving multiple fluid flow rates through the filter housing while enabling the fluid to remain in the housing for the same residence time. The housing insert can enable the housing to be formed of a first material while the housing insert is formed of a second material.

### CROSS-REFERENCE TO RELATED APPLICATIONS

This application claims priority of U.S. Provisional Application Serial No. 60/252,797, filed Nov. 21, 2001, which is incorporated herein by reference.

### BACKGROUND OF THE INVENTION

1. Field of the Invention

This invention relates to a filtering apparatus and more particularly to an improved insert for a filter housing that enables a user to control the residence time the fluid remains in the filter housing with different flow rates.

2. Description of the Related Art

Synthetic fibers for clothing and other applications are made by extruding plastic materials such as polymers through fine holes measuring only a few mils in diameter and located in spinnerettes. If the polymer melt contains granules of hardened plastic, metal particles from the extrusion machine, gels of incompletely mixed dyestuffs or other contaminants, the fine orifices in the spinnerettes become clogged and the individual filaments forming the fibers break. When the spinnerettes become clogged, the extrusion machine must be shut down, partially disassembled and cleaned. Once the spinnerettes are cleaned and reassembled, the fibers must be restrung on the high-speed winding machines before production can be resumed. The disassembling, cleaning and reassembling of the spinnerettes require the use of skilled labor, and the combination of service costs plus the value of lost production is very expensive. Accordingly, the known plastic extruding machines have employed filter housings containing filters to remove contaminants to extend the service life of the spinnerettes.

Most polymer filtration systems operate at a high pressure, typically 3000-5000 PSIG, and a high temperature, typically 500° F. to 600° F. The housings must have a thick housing sidewall and thick housing end covers to accommodate for the high pressure. Furthermore, the housing must be heated by either an integral heating jacket or be placed within a heating vessel with a controlled air gap between the housing and heating vessel.

Polymers such as polyester, polypropylene, nylon, and the like are very sensitive to time during the processing stage. The period from initial chemical reaction, or remelt and extrusion, to the final product creation is commonly referred to as residence time. Therefore, the time required for the polymer to flow from the inlet process connection to the outlet process connection is the residence time for the filtration system. The residence time of the filtration system is dependent on the internal volume of the system and the flow rate of the polymer through the system.

Therefore, it is desirable to have a housing assembly that can be adapted to receive fluid flow at multiple flow rates while maintaining the same residence time within the housing. It is also desirable to minimize the cost associated with manufacturing the housing assembly. Although these problems have existed in the prior art for a significant period of time, the prior art has failed to provide an adequate solution for these problems.

### SUMMARY OF THE INVENTION

One embodiment of the invention is a filtration system for filtering polymer material, wherein the filtration system includes an input end cover defining an input chamber, an output end cover defining an output chamber, and a housing extending between the input end cover and the output end cover. The housing defines an internal cavity with a first volume such that a fluid flowing from the input chamber to the output chamber through said internal cavity at a first flow rate remains within said housing for a desired residence time. The filtration system further includes a housing insert removably insertable within the internal cavity of the housing, wherein the housing insert reduces the volume of the internal cavity to a second volume such that a fluid flowing at a second reduced flow rate through the housing with the inserted housing insert remains within said housing for substantially the same desired residence time.

Another embodiment of the invention is a filtration system, wherein the filtration system includes a housing extending between a first and a second housing end, said housing have an internal housing sidewall defining an internal cavity, wherein said housing is formed of a first material. The filtration system further includes an input and an output port communicating with said internal cavity for enabling a flowing fluid to flow through said internal cavity of said housing, and a housing insert formed of a second material receivable within said internal cavity for overlying said internal housing sidewall of said internal chamber for preventing the fluid from contacting said first material of said housing.

Another embodiment of the invention is a method of accommodating a change in a flow rate of a polymer through a filtration system while maintaining a residence time of the polymer in the filtration system substantially constant. The method includes inserting a housing insert into an internal cavity of the filtration system in order to reduce a volume of the internal cavity in the filtration system.

Another embodiment of the invention is a filtration system for filtering polymer material, wherein the filtration system includes a housing defining an internal cavity with a first volume such that the polymer material flowing through said internal cavity at a first flow rate remains within said housing for a desired residence time. The filtration system also includes a plurality of housing inserts removably insertable within the internal cavity of the housing, wherein each of the plurality of housing inserts reduces the volume of the internal cavity to different volume smaller than the first volume such that the polymer material flowing at a reduced flow rate through the housing with at least one of the plurality of housing inserts contained therein remains within said housing for substantially the same desired residence time.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1 is an isometric view of a portion of a polymer filtration system including plural filtration units;

FIG. 2 is an enlarged cross-sectional view along line 2-2 in FIG. 1 illustrating an embodiment of a filtration unit of FIG. 1;

FIG. 3 is an enlarged view of an input end cover of the filtration unit of FIG. 2;

FIG. 4 is an enlarged view of an output end cover of the filtration unit of FIG. 2;

FIG. 5 is a top view of the filtration unit of FIG. 2;

FIG. 6 is a cross-sectional view of the filtration unit taken along line 6-6 of FIG. 2;

FIG. 7 is a cross-sectional view of the filtration unit taken along line 7-7 of FIG. 2;

FIG. 8 is a cross-sectional view of the filtration unit of FIG. 2 illustrating a housing insert received within a housing of the filtration unit according to one embodiment of the invention;

FIG. 9 is an enlarged view of the output end cover of the filtration unit of FIG. 8;

FIG. 10 is an enlarged view of the input end cover of the filtration unit of FIG. 8;

FIG. 11 is a cross-sectional view of the filtration unit taken along line 11-11 of FIG. 8;

FIG. 12 is a cross-sectional view of the filtration unit taken along line 12-12 of FIG. 8;

FIG. 13 is a cross-sectional view of a filtration unit taken along line 2-2 of FIG. 1 illustrating a second embodiment of a filter housing with a housing insert located therein.

### DETAILED DESCRIPTION OF THE PREFERRED EMBODIMENT

The following presents a detailed description of embodiments of the invention. However, the invention can be embodied in a multitude of different ways as defined and covered by the claims. The invention is more general than the embodiments that are explicitly described, and is not limited by the specific embodiments but rather is defined by the appended claims.

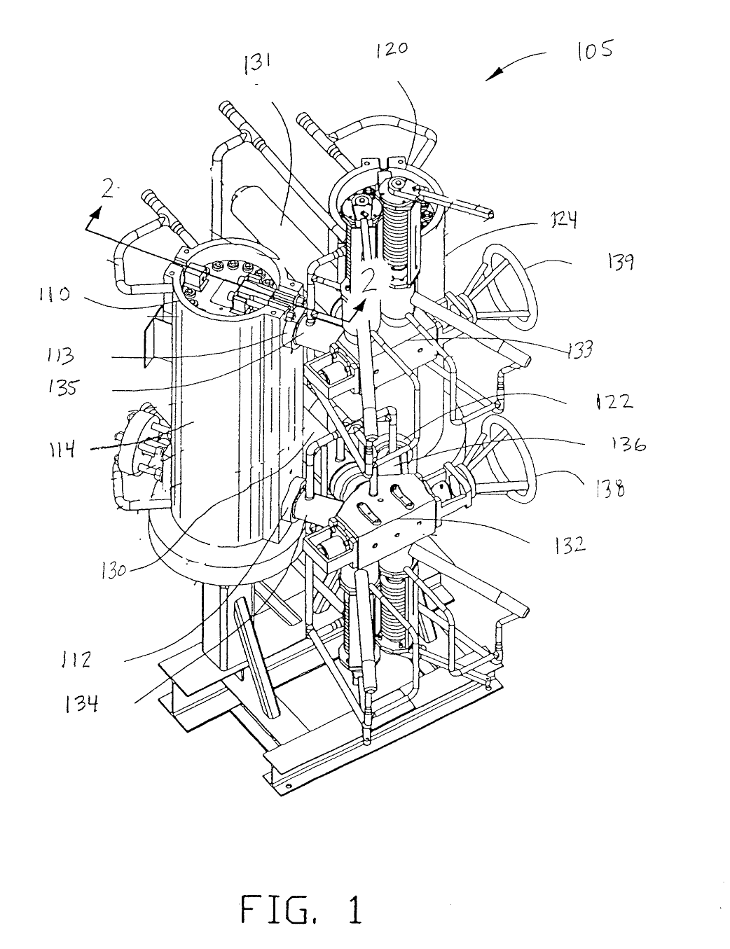

FIG. 1 is a perspective view of an embodiment of a polymer filtration system 105 for use with a plastic extrusion machine. The polymer filtration system 105 includes a first filtration unit 110 and a second filtration unit 120 connected between an input supply line 130 and an output supply line 131 for filtering a fluid. The filtration system can be used to filter polymers such as polylactic acid (PLA), polyethylene terapthalate (PET), polyester and other similar specialty polymers and the like. An input diverter valve 132 connects the input supply line 130 to the first and second filtration units 110 and 120. An output diverter valve 133 connects the first and second filtration units 110 and 120 to the output supply line 131.

The first filtration unit 110 includes a first input port 112 and a first output port 113 communicating with a filter housing assembly 114. The filter housing assembly 114 contains a filter element (not shown) for removing particles and other contaminants from the fluid.

Similarly, the second filtration unit 120 includes a second input port 122 and a second output port (not shown) communicating with a filter housing assembly 124. The filter housing assembly 124 contains a filter element (not shown) for removing particles and other contaminants from the fluid. Preferably, the first filtration unit 110 is substantially the same as the second filtration unit 120.

The input diverter valve 132 directs flow from the input supply line 130 to a first input line 134 that directs the flow to the first filtration unit 110 or to a second input line 136 that directs the flow to the second filtration unit 120. A repositionable input valve element (not shown) is located within the input diverter valve 132 for connecting only one of the first and second input lines 134 and 136 to the input supply line 130. An input actuator wheel 138 positions the input valve element. The first and second input lines 134 and 136 of the input diverter valve 132 are connected to the respective first input ports 112 and 122 of the first and second filtration units 110 and 20.

Similarly, the output diverter valve 133 receives flow from a first output line 135 or a second output line 137 and directs the flow to the output supply line 131. An output valve element (not shown) is located within the output diverter valve 131 for connecting only one of the first and second output lines 135 and 137 to the output supply line 131. An output actuator wheel 139 actuates the output valve element. The first and second output lines 135 and 137 of the output diverter valve 133 are connected to the first and second output ports 113 and 123 of the respective first and second filtration units 110 and 120. Preferably, the output diverter valve 133 is substantially the same as the input diverter valve 132.

The input and output valve actuators 138 and 139 may be adjusted to direct the fluid from the input supply line 130 to pass through the first filtration unit 110 to be discharged from the output supply line 131. The filter element of the first filtration unit 110 removes particles and other contaminants from the fluid prior to the fluid being discharged to the output supply line 131. The filtered fluid is discharged from the output supply line 131 and may be connected to a spinneret of a plastic extrusion machine (not shown).

When the filter element becomes clogged with particles and other contaminants, an operator adjusts the input and output valve actuators 138 and 139 for directing the fluid from the input supply line 130 to pass through the second filtration unit 120 to be discharged from the output supply line 131. The filter element of the second filtration unit 120 then removes particles and other contaminants from the fluid prior to the fluid being discharged to the output supply line 131.

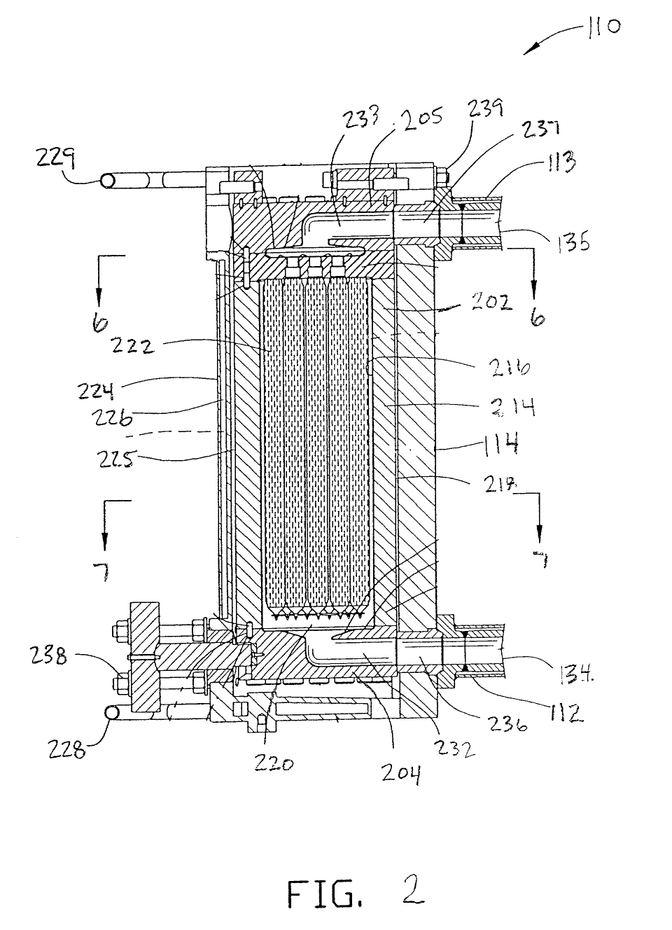

FIG. 2 is a cross-sectional view of the first filtration unit 110 of FIG. 1 and illustrates an embodiment of the first housing assembly 114. Preferably, the housing assembly 114 in the first filtration unit 110 is substantially similar to the housing assembly 124 in the second filtration unit 120 of FIG. 1 such that the housing assembly 114 is suitable for use in either the first or second filtration units 110 and 120 of FIG. 1.

The housing assembly 114 comprises a housing 202 extending between an input end cover 204 and an output end cover 205. In one embodiment, the housing 202 includes a cylindrical sidewall 214 having an interior surface 216 and an exterior surface 218. Alternately, the housing 202 can have other shapes, such as oval, hexagonal and the like. The interior surface 216 of the cylindrical sidewall 214 defines an internal cavity 220. The internal cavity 220 houses a number of filter elements 222. The filter elements 222 can be commercially available filters for use in filtering polymer material. The housing 202 can be formed from a high quality corrosion resistant material such as 300 and 400 series stainless steels, 17-4Ph stainless steel, inconel, hastelloy, carbon steel, etc.

The housing assembly 114 includes a heat exchanger 224 for maintaining the temperature of the fluid as the fluid passes through the first filtration unit 110 or second filtration unit 20. The heat exchanger 224 includes a heat exchanger cavity 226 for receiving a heat transfer media such as a heated transfer liquid or heated transfer vapor or the like. Heat transfer media lines 228 and 229 circulate the heat transfer media for heating the housing assembly 114. The exterior surface 218 of the cylindrical sidewall 214 is in thermal communication with the heat exchanger 224. The heat exchanger 224 is spaced from the exterior surface 218 of the cylindrical sidewall 214 by an annular space 225. The annular space 225 enables the desired thermal communication between the heat exchanger 224 and the housing 202.

An input chamber 232 permits the passage of fluid through the input end cover 204. Similarly, an output chamber 233 permits the passage of fluid through the output end cover 205. The input and output chambers 232 and 233 communicate with the respective input line 134 and output line 135 of the polymer filtration system 105 of FIG. 1 through an input compression bushing 236 and an output compression bushing 237. An input compression device shown as bolt 238 and an output compression device shown as bolt 239 compress the input and output compression bushings 236 and 237 for sealing the input and output chambers 232 and 233 to the respective input and output lines 134 and 33. Fluid flow is directed from the input line 134 through the input chamber 232 into the housing chamber 220. From the housing chamber 220, the fluid flows into the filter elements 222 and is directed through the output chamber 233 as will be explained below to the output line 135.

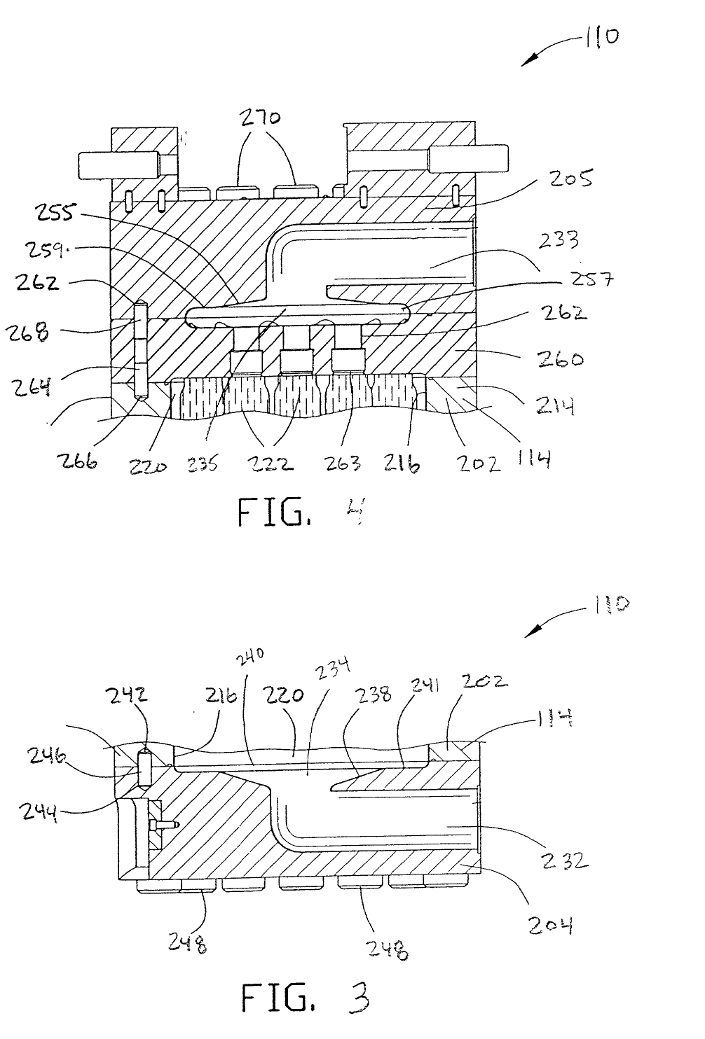

FIG. 3 is an enlarged view of the input end cover 204 forming a part of the housing assembly 114 shown in FIG. 2. The input end cover 204 contains the input chamber 232 communicating with the internal cavity 220 of the housing 202 for enabling the fluid to flow from the input port 112 into the internal cavity 220.

The input chamber 232 includes an orifice 234 for distributing the fluid into the internal cavity 220 of the housing 202. The orifice 234 includes a truncated conical portion 238 that terminates with an opening with a diameter substantially less than the diameter of the interior surface 216 of the cylindrical sidewall 214. The orifice 234 also includes a cylindrical portion 240. The cylindrical portion 240 provides a transition from the conical portion 238 of the orifice 234 to internal cavity 220. As shown in the embodiment in FIG. 3, the cylindrical portion 240 has a diameter substantially equal to the diameter of the interior surface 216 of the cylindrical sidewall 214 so the fluid flows smoothly from the orifice 234 to the internal cavity 220. Preferably, the cylindrical portion 240 has a substantially flat bottom surface 241.

The housing 202 includes an orientation aperture 242 adjacent to the input end cover 204. The input end cover 204 also includes an orientation aperture 244 adjacent to the orientation aperture 242 in the housing 202. The orientation apertures 242 and 244 receive an orientation pin 246 to orient the input end cover 204 relative to the housing 202. A plurality of mechanical fasteners 248 shown as bolts secure the input end cover 204 to the housing 202.

FIG. 4 is an enlarged view of the output end cover 205 of the housing assembly 114 shown in FIG. 2 and the output chamber 233. The output chamber 233 includes an orifice 235 for receiving the fluid from the filter elements 222. The orifice 235 includes a truncated conical portion 255 that terminates with a diameter substantially smaller than the diameter of the interior surface 216 of the cylindrical sidewall 214. The orifice 235 also includes an cylindrical portion 257 in the output end cover 205. In one embodiment, the cylindrical portion 257 has a diameter substantially equal to the diameter of the interior surface 216 of the cylindrical sidewall 214. Preferably, the cylindrical portion 257 has a substantially flat top surface 241.

A tubesheet 260 is interposed between the housing 202 and the output end cover 205. The tubesheet 260 includes a plurality of flow apertures 262 extending through the tubesheet 260. The tubesheet 260 contains sockets 263 that receive a portion of the plurality of filter elements 222. Preferably, the plurality of filter elements 222 are threadably secured into the sockets 263 of the tubesheet 260. Fluid flow is directed through the filter elements 222, through the apertures 262 in the tubesheet 260 to the orifice 235 in the output chamber 233

The output end cover 205 includes an orientation aperture 262 for cooperation with an orientation aperture 264 in the tubesheet 260. The orientation aperture 264 in the tubesheet 260 cooperates with an orientation aperture 266 in the housing 202. A second orientation pin 268 extends through orientation apertures in the output 262, 264 and 266 to orient the tubesheet 260 relative to the housing 202 and the output end cover 205.

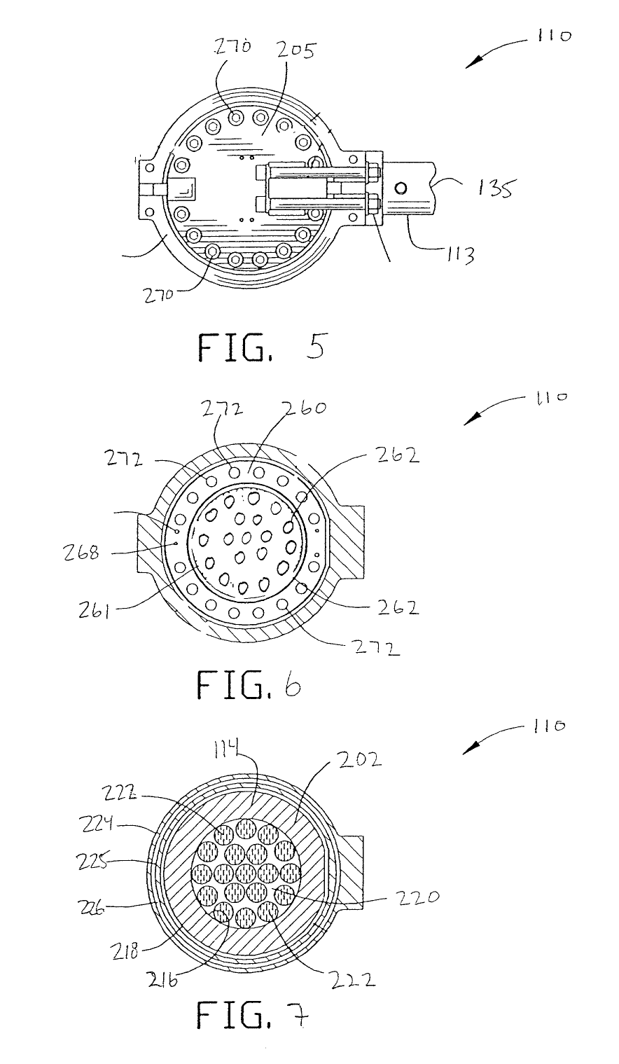

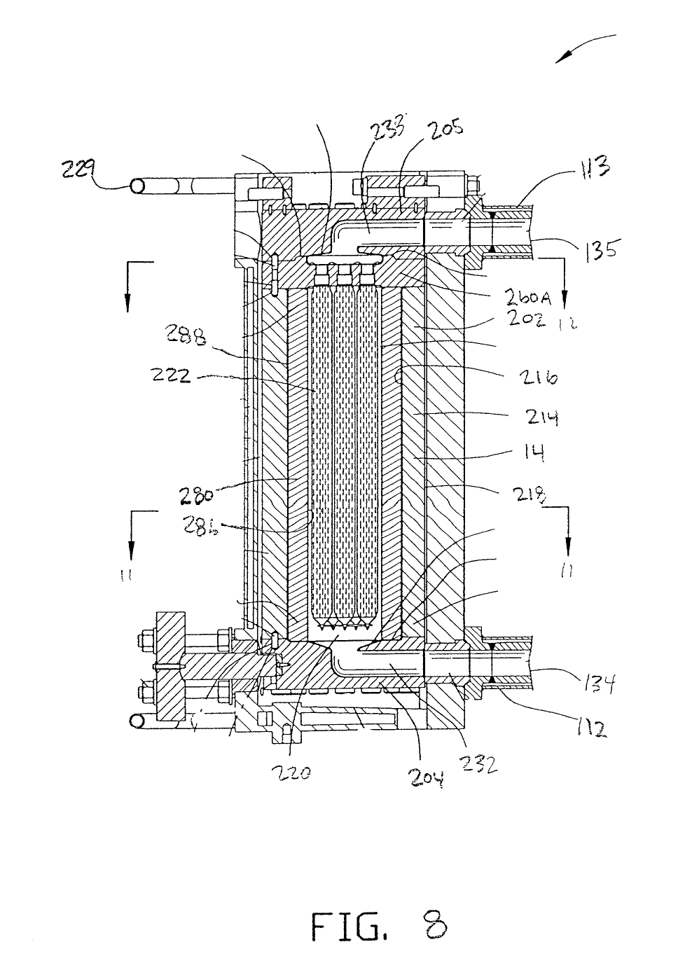

FIG. 5 is a top view of the housing assembly 110 and illustrates that a plurality of mechanical fasteners 270 secure the output end cover 205 to the housing 202 (not shown). FIG. 6 is a cross sectional view of the tubesheet 260. Drill holes 272 extend through the tubesheet 260 allowing the mechanical fasteners 270 (not shown) to secure the tubesheet 260 between the output end cover 205 and the housing 202. Flow apertures 262 in a flow aperture region 261 direct the fluid flow through the tubesheet 260. The flow aperture region 261 has a diameter substantially the same as the diameter of the cylindrical portion 257 of the orifice 235. FIG. 7 is a cross sectional view of the housing 202. FIG. 7 illustrates that the internal cavity 220 houses several filter elements 222.

FIG. 8 illustrates an embodiment of the housing assembly 114 with the insertion of a housing insert 280 within the internal cavity 220 of the housing 202. The housing insert 280 reduces the volume of the internal cavity 220 enabling a fluid to flow through the housing assembly 114 at a reduced flow rate but still have the same residence time within the housing assembly 114.

A typical filtration system can only accommodate relatively small variations in the flow rate of the polymer without having adverse effects on the quality of the finished product. Each polymer has a limited time from initial chemical reaction to final product output, be it chip, yarn or film. If the process is not completed in this time, the molecular structure of the polymer will begin to break down. This time span to pass through all the piping and equipment in the process line is called total residence time. The allowable total residence time varies with operating conditions and polymer makeup. A portion of the total residence time is spent in the housing assembly 114 of FIG. 2 and is referred to herein as the filter residence time or simply residence time. However, due to product supply or demand, it is often desirable or necessary to operate the process line and hence the filtration system at widely different flow rates. If a significantly different flow rate is required, a different housing having a different internal volume has been employed to provide the same residence time at the significantly different flow rate. Accordingly, different housings of varying internal volumes must be provided for adapting a typical polymer filtration system for significantly different flow rates of fluid.

To preserve compatibility with the remainder of the filtration system, it is desirable to have constant outer dimensions of the filter housing. This requires filter housings with varying thickness of the housing sidewalls. Excessively thick housing sidewalls add significantly to the cost of the housing, especially when the housing sidewall is made from a costly material such as stainless steel.

The housing insert 280 is shaped so that it can be received into the internal cavity 220 of the housing 202. In one embodiment, the housing insert 280 is a substantially cylindrical sleeve extending between the input end cover 204 and the output end cover 205. The housing insert 280 has a cylindrical sidewall 284 having an interior surface 286 and an exterior surface 288. The housing insert 280 is slidably received within the housing 202 to reduce the volume of the cylindrical internal cavity 220. The housing insert 280 is engagable with the interior surface 216 of the cylindrical sidewall 214 of the housing 202 for supporting the housing insert 280. The housing insert 280 has a sleeve thickness sufficient for reducing the volume of the cylindrical internal cavity 220 by a desired amount with respect to the volume of the internal cavity 220 when the housing insert 280 is not within the housing 202. In one example, the housing 202 has a length of 20.00 inches. The internal diameter of the housing is 7.81 inches. Thus, the internal cavity 220 has a volume of 958 cubic inches. A housing insert used with this housing has an internal diameter of 4.63 inches. With the housing insert installed, the volume of the internal cavity 220 is reduced to 621 cubic inches. This provided a reduction of 65%. Other preferable internal diameter combinations of housings and housing inserts are (in inches): 13.25/7.81, 18.75/13.25, 27.00/18.75, 34.50/27.00. Of course, these are representative of preferred embodiments and other combinations are conceived in the scope of the invention

The reduced volume enables fluid flowing at a second reduced flow rate through the housing assembly 114 to have substantially the same residence time as fluid flowing at the higher flow rate through the housing assembly 114 without the housing insert 280 installed. Basically, the residence time equals the housing volume divided by the flow rate. It is preferable that the residence time not vary by more than +/−15%, more preferably +/−7% and most preferably +/−3%.

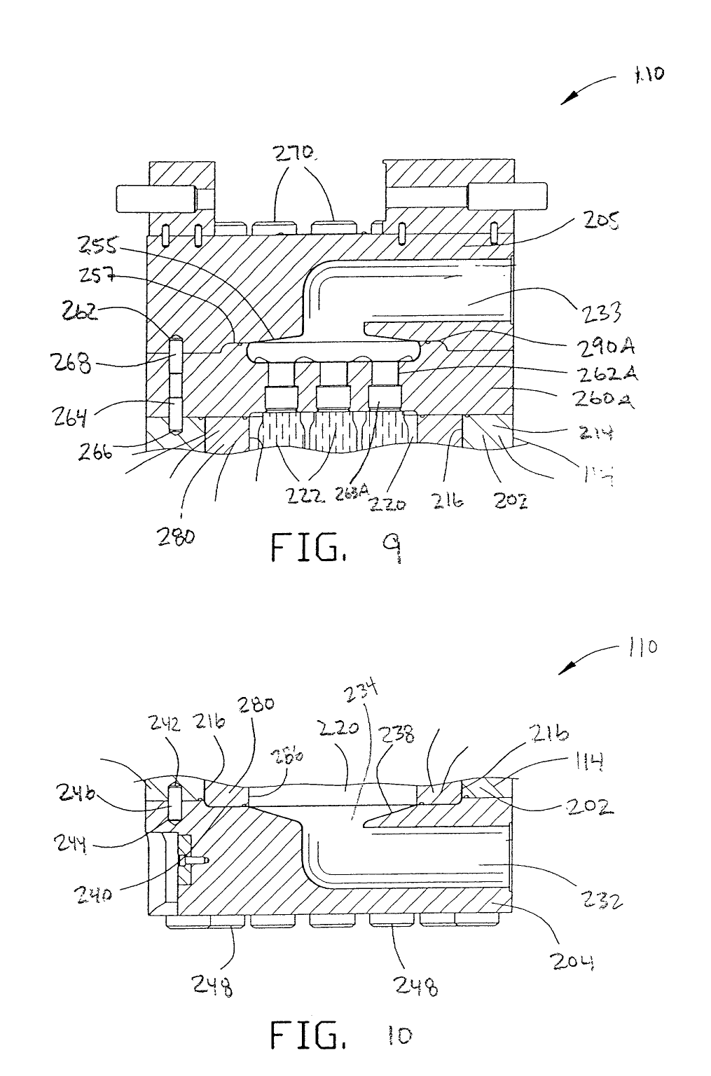

FIG. 9 is an enlarged view of the output end cover 205 and a tubesheet 260A forming a part of the housing assembly 114 shown in FIG. 8. The output end cover 205 is substantially similar to the output end cover 205 shown in FIG. 4. The tubesheet 260A is interposed between the housing 202 and the output end cover 205. The tubesheet 260A includes a plurality of flow apertures 262A extending through the tubesheet 260A. The tubesheet 260A contains sockets 263A that receive a portion of the plurality of filter elements 222. It can be seen that fewer filter elements 222 can fit in the internal cavity 220 of the housing 202 with the housing insert 280 installed relative to the number of the filter elements 222 within the internal cavity 220 without the housing insert 280 as shown in FIG. 2. As such, the number flow apertures 262A and sockets 263A in the tubesheet 260A is reduced relative to the number of flow apertures 262 and sockets 263 in the tubesheet 260 of FIG. 6.

The tubesheet 260A includes an annular filler ring 290A. The annular filler ring 290A is configured to be received within the cylindrical portion 257 of the orifice 235 to reduce the effective diameter of the orifice. The filler ring 290A prevents localized pockets of fluid from becoming trapped in low flow areas near the outer edges in the cylindrical portion 257 of the orifice 235 and degrading because of an increased resident time in the housing assembly 114. In one embodiment, the annular filler ring 290A is such that the diameter of the conical portion 255 of the orifice 235 is the same as the diameter of the interior surface 286 of the housing insert 280 so that fluid flows from the filter elements 222, through the apertures 262A and into the conical portion 255 of the orifice 235. Accordingly, the orifice 235 can accommodate for either the diameter of the interior surface 216 of the cylindrical sidewall 214 or the diameter of the interior surface 286 of the housing insert 280 without the formation of substantial eddy currents or dead spots or locations of stagnant fluid flow that would increase the resident time for portions of the fluid flowing through the housing assembly 114.

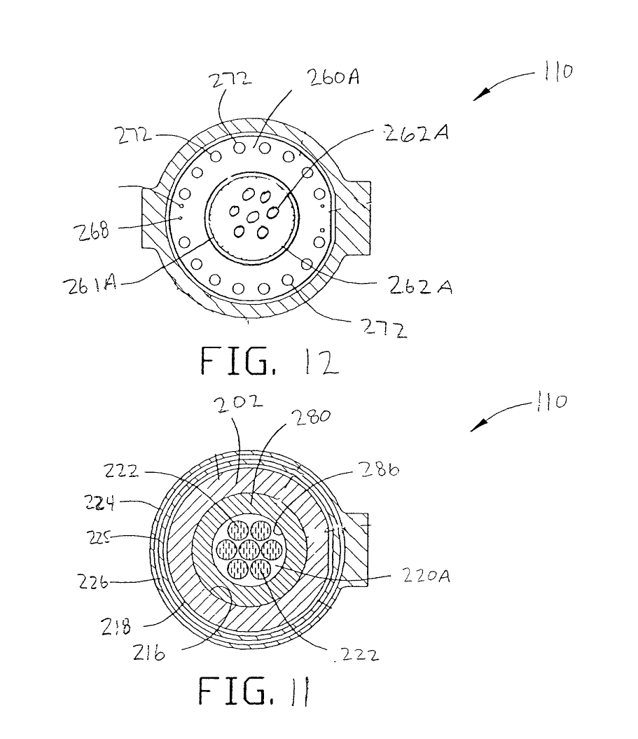

FIG. 10 is an enlarged view of the input end cover 204 forming a part of the housing assembly 114 shown in FIG. 8. The input end cover 204 is substantially similar to the input end cover 204 shown in FIG. 3. FIG. 10 illustrates that the housing insert 280 is received in the cylindrical portion 240 of the orifice 234. The base of the conical portion 238 has a diameter substantially the same as the diameter of the interior surface 286 of the housing insert 280 allowing a smooth transition for the fluid as it flows through the housing assembly 114.

FIG. 11 is a cross sectional view of the housing 202 with the housing insert 280 installed. As can be seen, there are fewer filter elements 222 within the internal cavity 220 of the housing insert 280 relative to the number of the filter elements 222 installed within the internal cavity 220 without the housing insert as shown in FIG. 6.

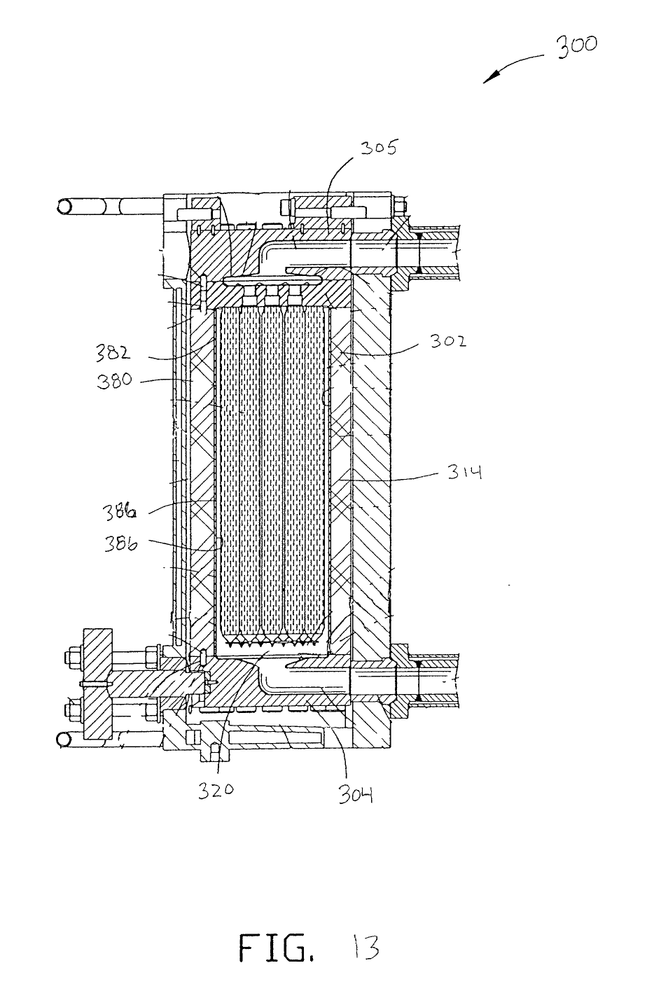

FIG. 12 is a cross sectional view of the tubesheet 260A. As with the tubesheet 260 in FIG. 6, drill holes 272 extend through the tubesheet 260A allowing the mechanical fasteners 270 (not shown) to secure the tubesheet 260A between the output end cover 205 and the housing 202. Flow apertures 262A in a flow aperture region 261A direct the fluid flow through the tubesheet 260A. The flow aperture region 261A has a diameter substantially the same as the diameter of the conical portion 255 of the orifice 235. As such, the number of flow apertures 262A extending through the tubesheet 260A is reduced relative to the number in the tubesheet 260 of FIG. 6.

Additionally, the housing assembly 114 of FIG. 8 can receive housing inserts 280 of different sizes, such that the system can accommodate multiple flow rates. The smallest housing insert would have an interior surface 286 with an inside diameter equal to the diameter of conical portion 255 of the orifice 235. In one embodiment, the housing inserts 280 can have different wall thicknesses resulting in different internal diameters such that different internal cavity 220 volumes are achieved. In another embodiment, a smaller housing insert can nest within a larger housing insert providing successively smaller internal cavity 220 volumes.

As can be seen from the above embodiment, in order to maintain the same residence time with a reduced flow rate of the fluid, the effective volume of the housing chamber 220 must be reduced. The housing insert 280 allows for a reduced flow rate of the fluid through the housing 202 by effectively reducing the diameter of the housing 202, thus reducing the volume of the internal cavity 220.

The reduction in the effective volume of the internal cavity 220 is accomplished through the addition of the housing insert 280. The housing insert 280 cooperates with the tubesheet 260A to minimize areas of stagnant flow through the housing assembly 114 when the housing insert 280 is installed. Preferably, the same input and output end covers 204 and 205 can be used by the housing 202 with or without the housing insert 280 installed. Typically, the housing insert 280 is formed from a high quality material such as stainless steel material.

FIG. 13 illustrates another embodiment of a housing assembly 300. The housing assembly 300 comprises a housing 302 extending between an input end cover 304 and an output end cover 305. The housing 302 includes a cylindrical sidewall 314. The cylindrical sidewall 314 defines an internal cavity 320. A housing insert 380 is positioned within the internal cavity 320 of the housing 302.

The housing insert 380 comprises a substantially cylindrical housing sleeve extending between the input end cover 304 and the output end cover 305. The housing insert 380 defines a cylindrical sidewall 382 having an interior surface 386 and an exterior surface 388. The housing insert 380 is slidably received with the cylindrical internal cavity 320. The housing insert 380 is engagable with the cylindrical sidewall 314 of the housing 302 for supporting the housing insert 380. The housing insert 380 has a sleeve thickness substantially less than a thickness of the cylindrical sidewall 314 of the housing 302.

In this embodiment of the invention, the housing 302 comprises a lower cost material such as a carbon steel material. In other embodiments, 300 or 400 series stainless steel and the like can be used for the housing. A lower quality, less corrosion resistant material can be used because the fluid flowing through the housing assembly 114 will not come in contact with the housing 302. Therefore, the material that the housing is made of need not possess the corrosion resistant qualities as the portions of the housing assembly 114 that will come in contact with the fluid. The housing insert 380 comprises a higher quality, more corrosion resistant material such as stainless steel. Alternately, inconel, hastelloy and the like can be used for the insert 380. The housing insert 380 overlies the interior sidewall 314 of the housing 302 for preventing the fluid from contacting with the lower quality metallic material of the housing 302.

In the alternative, the housing insert 380 may have a sleeve thickness sufficient for reducing the volume of the cylindrical internal cavity 320 to provide a second reduced flow rate of the fluid through the housing assembly 300 with the same residence time. Thus, multiple housing inserts 380 can be prepared, each with a different sleeve thickness, and the housing insert 380 to be installed can be chosen based on the required flow rate through the housing assembly 114. The use of a lower cost material for the housing 302 and a higher cost material for the housing insert 380 significantly reduces the cost of the polymer filtration system 105.

One embodiment of a filtration system for filtering polymer material comprises a housing defining an internal cavity, and a plurality of housing inserts. The internal cavity has a first volume such that the polymer material flows through the internal cavity at a first flow rate, and remains within the housing for a desired residence time.

The housing inserts can be removably inserted within the internal cavity of the housing, wherein each housing insert can reduce the volume of the internal cavity to a different volume smaller than the original volume of the internal cavity. When at least one housing insert is contained within the housing, the polymer material flows through the housing at a reduced flow rate, and the polymer material remains within the housing for substantially the same desired residence time as when no housing insert is contained within the housing.

The housing inserts can be configured such that one insert can be nested within another housing insert, or the inserts can be configured such that only one insert fits within the internal cavity at a time.

Accordingly, in this embodiment of the invention, the filtration system can accommodate a variety of different flow rates, allowing a user of the system to attenuate output in a dynamic manner without having to employ multiple different filtration housings. Instead, a variety of housing inserts can be used that permit adjustment of flow rate anywhere between a maximum allowed by the housing without an insert, to a minimum allowed by an insert or a plurality of inserts working together, which approach a practical limit of internal diameter.

The embodiments described herein use the example where the housing is used to modify the interior cavity 220 volume to allow for different flow rates through the housing assembly 114. One skilled in the art, however, will understand that other parameters can affect the resident time in the housing assembly 114. For example, the type of filter used in the housing assembly 114 can cause different resistances to flow through the housing assembly. Housing inserts 280 can be used to adjust for these other parameters as well.

Specific parts, shapes, materials, functions and modules have been set forth, herein. However, a skilled technologist will realize that there are many ways to fabricate the system of one embodiment of the invention, and that there are many parts, components, modules or functions that may be substituted for those listed above. While the above detailed description has shown, described, and pointed out fundamental novel features of the invention as applied to various embodiments, it will be understood that various omissions and substitutions and changes in the form and details of the components illustrated may be made by those skilled in the art, without departing from the spirit or essential characteristics of the invention.

What is claimed is:

1. A filtration system for filtering polymer material, the filtration system comprising:
an input end cover defining an input chamber;
an output end cover defining an output chamber;
a housing extending between the input end cover and the output end cover, wherein the housing defines an internal cavity with a first volume such that a fluid flowing from the input chamber to the output chamber through said internal cavity at a first flow rate remains within said housing for a desired residence time; and
a housing insert removably insertable within the internal cavity of the housing, wherein the housing insert reduces the volume of the internal cavity to a second volume such that a fluid flowing at a second reduced flow rate through the housing with the inserted housing insert remains within said housing for substantially the same desired residence time.

2. The filtration system of claim 1, wherein the housing comprises a cylindrical sidewall.

3. The filtration system of claim 2, wherein the housing insert comprises a cylindrical sleeve.

4. The filtration system of claim 3, wherein the input chamber has a first conical portion and second cylindrical portion, wherein the base of the conical portion has a diameter smaller than the base of the cylindrical portion.

5. The filtration system of claim 4, wherein the diameter of the cylindrical portion is substantially the same as the diameter of an interior surface of the cylindrical sidewall of the housing.

6. The filtration system of claim 5, wherein the diameter of the base of the conical portion is substantially the same as the diameter of an interior surface of the cylindrical sleeve of the housing insert.

7. The filtration system of claim 3, wherein the output chamber has a conical portion and cylindrical portion, wherein the diameter of the base of the conical portion is smaller than the base of the cylindrical portion.

8. The filtration system of claim 7, further comprising a tubesheet section mating the housing with the output end cover.

9. The filtration system of claim 8, wherein the tubesheet section comprises a first tubesheet member for use when the housing insert is not inserted within the housing or a second tubesheet member for use when the housing insert is inserted within the housing.

10. The filtration system of claim 9, wherein the second tubesheet member has an annular filler ring on an upper surface thereof, wherein the annular filler ring is received within the cylindrical portion of the output chamber.

11. The filtration system of claim 10, wherein the annular filler ring reduces the effective diameter of the cylindrical portion of the output chamber.

12. The filtration system of claim 1, wherein the residence time is a duration of time it takes for the polymer material to flow from the input chamber to the output chamber.

13. A filtration system for filtering polymer material, the filtration system comprising:
a housing defining an internal cavity with a first volume such that the polymer material flowing through said internal cavity at a first flow rate remains within said housing for a desired residence time; and
a housing insert removably insertable within the internal cavity of the housing, wherein the housing insert reduces the volume of the internal cavity to a second volume such that the polymer material flowing at a second reduced flow rate through the housing with the inserted housing insert remains within said housing for substantially the same desired residence time.

14. A filtration system for filtering polymer material, the filtration system comprising:
a housing extending between a first and a second end caps, said housing comprising an internal housing sidewall defining an internal cavity;
an input port communicating with said internal cavity for enabling a flowing polymer material to enter into said internal cavity of said housing;
an output port communicating with said internal cavity for enabling the polymer material to flow through said internal cavity of said housing at a first flow rate while remaining within said housing for a desired residence time; and
a housing insert receivable within said internal cavity for enabling the polymer material to flow through said internal cavity of said housing at a second flow rate while remaining within said housing for substantially the same residence time.

15. A filtration system comprising:
a housing extending between a first and a second housing end, said housing have an internal housing sidewall defining an internal cavity, wherein said housing is formed of a first material;
an input and an output port communicating with said internal cavity for enabling a flowing fluid to flow through said internal cavity of said housing; and
a housing insert formed of a second material receivable within said internal cavity for overlying said internal housing sidewall of said internal chamber for preventing the fluid from contacting said first material of said housing.

16. The filtration system of claim 15, wherein the first material differs from the second material based on a characteristic selected from the group consisting of: material cost, chemical resistance and heat resistance.

17. The filtration system of claim 15, wherein:
said housing comprises a carbon steel material; and
said housing insert comprising a stainless steel material.

18. The filtration system of claim 15, wherein:
said housing includes an input end cover and an output end cover secured to said first and second housing ends; and
said input and output ports being defined in said input end cover and said output end cover, respectively.

19. The filtration system of claim 18, wherein said housing insert comprises a housing sleeve slidably received within said internal housing sidewall of said internal cavity of said housing.

20. A method of accommodating a change in a flow rate of a polymer through a filtration system while maintaining a residence time of the polymer in the filtration system substantially constant, the method comprising inserting a housing insert into an internal cavity of the filtration system in order to reduce a volume of the internal cavity in the filtration system.

21. The method of claim 20, further comprising inserting a tubesheet with a filler ring, wherein the filler ring fits into an orifice in the filtration system to reduce the effective diameter of the orifice opening, such that an effective diameter is substantially the same as a diameter of the internal cavity within the housing insert.

22. The method of claim 21 wherein the housing insert is removably inserted into the filtration system.

23. A housing insert for use in a polymer filtration unit, wherein the housing insert is configured to be removably insertable within an internal cavity of the polymer filtration unit, wherein the housing insert reduces the volume of the internal cavity to a volume such that a polymer material flowing at a first flow rate through the polymer filtration unit with the incorporated housing insert remains within said polymer filtration unit for a desired residence time that is substantially the same as the residence time for a polymer material flowing through said polymer filtration unit without the housing insert at a second higher flow rate.

24. A filtration system for filtering polymer material, the filtration system comprising:
an input end cover defining an input chamber;
an output end cover defining an output chamber;
a housing extending between the input end cover and the output end cover, wherein the housing defines an internal cavity with a first volume such that a fluid flowing from the input chamber to the output chamber through said internal cavity at a first flow rate remains within said housing for a desired residence time; and
an insertable means for reducing the volume of the internal cavity to a second volume such that a fluid flowing at a second reduced flow rate through the housing with the inserted housing insert remains within said housing for substantially the same desired residence time.

25. The filtration system of claim 24, wherein the housing comprises a cylindrical sidewall.

26. The filtration system of claim 24, further comprising a tubesheet means for mating the housing with the output end cover.

27. The filtration system of claim 26, wherein the tubesheet means comprises a first means for use when the housing insert is not inserted within the housing and a second means for use when the housing insert is inserted within the housing.

28. The filtration system of claim 27, wherein the second means has an annular filler ring on an upper surface thereof, wherein the annular filler ring is received within a portion of the output chamber to reduce the effective diameter of the output chamber.

29. A filtration system for filtering polymer material, the filtration system comprising:
a housing defining an internal cavity with a first volume such that the polymer material flowing through said internal cavity at a first flow rate remains within said housing for a desired residence time; and
a plurality of housing inserts removably insertable within the internal cavity of the housing, wherein each of the plurality of housing inserts reduces the volume of the internal cavity to different volume smaller than the first volume such that the polymer material flowing at a reduced flow rate through the housing with at least one of the plurality of housing inserts contained therein remains within said housing for substantially the same desired residence time.

30. The filtration system of claim 29, wherein the housing inserts are configured such that one of the plurality of housing inserts fits within the cavity at a time.

31. The filtration system of claim 29, wherein at least one of the plurality of housing inserts is configured to be nested within another one of the plurality of housing inserts.
